(19) United States
(12) Patent Application Publication
(10) Pub. No.: US 2007/0061814 A1
(43) Pub. Date: Mar. 15, 2007

(54) Method and apparatus for transparently interfacing a computer peripheral with a messaging system

(76) Inventors: Andrew Chung-Kay Choi, Burlingame, CA (US); Michael Minhall Chang, San Francisco, CA (US)

Correspondence Address: David V. Sanker, 29 Domingo Ave, Berkeley, CA, 94705, US

(21) Appl. No.: 11/226,488

(22) Filed: Sep. 13, 2005

(51) Int. Cl. G06F 9/46

(52) U.S. Cl. 719/313

(57) ABSTRACT

A proxy application is installed locally to an existing messaging client application. The proxy is transparent in that it requires no modification to messaging client code implementation. The proxy monitors the incoming and outgoing messaging client data, analyzes the data based on configurable criteria, and in response issues configurable control commands to a peripheral device. The peripheral device may also act as an input device: the proxy may monitor the peripheral input data, analyze the data based on configurable criteria, and in response insert new data into the messaging data stream. In addition, the proxy may monitor other information external to the messaging system, such as new email notifications, in order to trigger both device actions and messaging data stream insertions. All local proxy configuration may be made available to remote messaging clients or proxies via an HTTP server or other means, so that the remote clients may preview the expected impact of their sent messages on the local system.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION—FIELD OF THE INVENTION

This invention relates to interfacing computer peripherals with messaging systems. The invention is applicable to both server-based and peer-to-peer systems. The invention is particularly suited to instant messaging systems but is also applicable to other messaging systems, including IRC, email, and SMS text messaging.

The proposed US classification is 709/206.

### BACKGROUND OF THE INVENTION

Instant messaging (IM) systems have become increasingly popular over the past decade. Much of their popularity derives from the medium's combination of immediacy with non-intrusiveness. Messages sent via IM can be viewed immediately if desired, but a recipient can also decide to ignore messages until a later, more convenient time without loss of message content.

A significant limitation of instant messages is expressiveness, which is constrained primarily to text. To compensate for this limitation, IM users have developed a rich vocabulary of “emoticons,” which are character sequences that resemble pictograms, such as smiley faces. Most Messaging Systems translate these character sequences to graphical icons that convey the implied emotion or expression: for example, :) may be translated to [symbol] , indicating happiness. One Messaging System add-on (IMPService, at www.impservice.com) has further enhanced the expressiveness of emoticons by using them to control avatar animations that are displayed in a separate application window. Other attempts to increase IM expressiveness include integration of audio, including audio clips played in response to emoticons and presence notifications. The U.S. Patent Application 2002/0194006 is representative. The primary drawback is that these expressiveness enhancements are limited to computer-based graphics and audio.

The “IM Buddies” product attempts to expand expressiveness. It is produced by United Internet Technologies (UIT) and covered by patent U.S. Pat. No. 6,370,597. This product attempts to bring IM emoticons to the physical world by using an Messaging System to control animatronic devices, which are capable of movement and audio output. However, the UIT system is significantly limited because it requires custom integration with the Messaging System. The UIT system requires modification of both IM server and client application code. Furthermore, the UIT system requires modifications to the standard IM (AOL Instant Messenger (“AIM”)) protocol. Since these limitations prevent the UIT system from being useable with existing unmodified Messaging Systems (even with an unmodified Messaging Client), few users have adopted the system. Few users are willing to change their Messaging Systems or even their Messaging Clients for non-essential features. This is due in large part to the inertia created by the community-based nature of Messaging Systems: a single individual cannot change to a new Messaging System and still communicate with his/her IM buddies unless all the buddies also change to the same system.

U.S. patent applications 2003/0078979, 2004/0267885, 2005/0021639, and 2005/0102362 take a different approach by embedding an Messaging Client directly into a peripheral device. There are several disadvantages of this approach. The primary drawback is that messages must be directed to the device itself, and each person who sends a message must code the message appropriately in order for the message to be correctly interpreted by the device. This becomes particularly difficult to manage when the person with a controllable peripheral device has a large number of “buddies.”

### BACKGROUND OF THE INVENTION—OBJECTS AND ADVANTAGES

The current invention provides increased expressiveness in messaging systems by integrating messaging systems with the physical world. This invention also enables broad adoption by not requiring modifications to messaging application programs. In addition, by using a proxy, this invention enables maximum flexibility while simultaneously providing the simplicity of a configuration that is managed solely by the owner of the peripheral device.

The current invention can operate in a mode analogous to that outlined in U.S. patent applications 2003/0078979 et al., where messages are sent directly to a peripheral device. But in the typical mode of operation, a message is sent to another user. The current invention then operates by monitoring the messages and transmitting commands to a peripheral device based on the content of the messages.

Further objects and advantages will become apparent from a consideration of the ensuing description and drawings.

### SUMMARY

A proxy application that transparently integrates into a messaging environment, monitors both incoming and outgoing messages, analyzes monitored messages, sends commands to a peripheral device and monitors activity of the same device, inserts additional messages into the messaging environment, and is configurable.

### BRIEF DESCRIPTION OF THE DRAWINGS

FIG. 1 depicts the proxy application of the present invention and the connection of the proxy application to other components.

FIG. 2 depicts the configuration aspects of the present invention.

FIG. 3 shows the inner workings of the proxy application of the present invention.

### DETAILED DESCRIPTION

The inventors hereby define the following terms, and these definitions apply both in the written specification and the claims:

The word “any,” when used in conjunction with the word “plurality” means any number between 0 and the entirety of the plurality, specifically allowing 0 (none) and the entirety (all) as possibilities.

A “command” is any instruction that can be communicated with a device.

A “client platform” can be a computer, a cellular phone, or any other electronic instrument upon which a “messaging client” may reside.

A “configuration means” is any process by which a person may view or modify the values associated with configuration parameters.

A “device” is any electronic instrument that can produce sensory output (i.e., anything that a person can perceive using eyes, ears, nose, touch, etc.) in response to electronic commands. Visual output includes physical motion.

A “message” is any digital data that is transferred to a messaging client.

A “messaging client” is software that a person uses to transmit, receive, compose, read, and manage digital messages. A “messaging client” communicates with other people over a “messaging system.”

A “messaging system” allows people to communicate using digital messages. A messaging system itself can also send messages on its own behalf: for example, to provide status information to users. Examples of “messaging systems” include AOL Instant Messenger, Yahoo! Messenger, Microsoft MSN Messenger, Cerulean Studios Trillian, Jabber Messenger, email, and SMS text messaging.

The word “or” is used in the broadest possible sense. Whenever the word “or” is used, this includes the possibilities of none, all, and any possibility in between the two extremes.

The adjective “transparent” means that the application of the current invention can be installed and operated without modification to the code of the local messaging client. In addition, no changes are necessary to the messaging system or any other messaging clients.

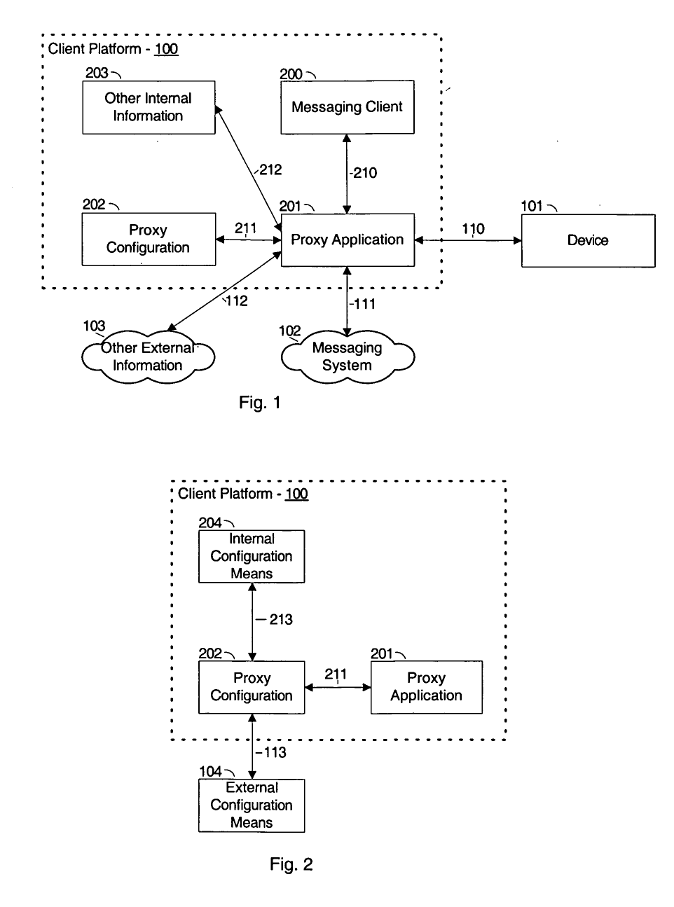

Referring to FIG. 1, the Messaging Client 200 could be AOL Instant Messenger, Yahoo! Messenger, Microsoft MSN Messenger, Cerulean Studios Trillian, Jabber Messenger, an email client, SMS text messaging, or any other application for sending, receiving, composing and/or reading digital messages. Importantly, the Messaging Client 200 requires no code modifications or other customization to support the present invention. Also, the Messaging Client 200 functions using server-based or peer-to-peer communication protocols. The Messaging System 102 represents the external entities with which the Messaging Client 200 communicates in order to transmit messages to other messaging clients. The Messaging System 102 can be a server that receives messaging requests and forwards the messages to destination clients, or it can be a peer-to-peer network in which messaging requests are routed to destination clients without relying on statically configured or centralized servers. In the case of peer-to-peer messaging, the Messaging System 102 can be an ad-hoc network of servers that route messages or simply another instance of a messaging client. The Messaging System 102 communicates with the Messaging Client 200 using shared common protocols. Just like the Messaging Client 200, the Messaging System 102 requires no code modification or other customization to support the present invention.

In a normal messaging environment, the Messaging Client 200 communicates directly with the Messaging System 102 to send and receive messages. The present invention inserts Proxy Application 201 in the communication path. The Proxy Application 201 can be a standard proxy through which the Messaging Client 200 can be explicitly configured to communicate. In this case the Proxy Application 201 uses a standard protocol. Standard protocols include, but are not limited to, HTTP, HTTPS, SOCKS 4, and SOCKS 5. In this case, the Messaging Client 200 directs all messages to the Proxy Application 201, and the proxy forwards the messages without modification to the Messaging System 102. Such a proxy is typically required for allowing communications in the presence of network firewalls. Data sent from the Messaging System 102 back to the Messaging Client 200 is also transmitted via the Proxy Application 201. As an alternative to using standard proxy configuration mechanisms, the Proxy Application 201 can use support in the client platform network protocol stack that allows it to intercept and optionally modify data between the Messaging Client 200 and Messaging System 102. In this case the Proxy Application 201 does not rely on standard proxy protocols such as HTTP or SOCKS, and would not require explicit configuration in the Messaging Client 200. The Proxy Application 201 can be used with both connection oriented protocols (such as TCP) and connectionless protocols (such as UDP).

In the present invention, the Proxy Application 201 can forward messages between the Messaging Client 200 and Messaging System 102 without modification. In such cases, the Messaging Client 200 and Messaging System 102 function as if the Proxy Application 201 were not present. The client-to-proxy data 210 is functionally equivalent to the proxy-to-system data 111, and the system-to-proxy data 111 is functionally equivalent to the proxy-to-client data 210.

The Proxy Application 201 of the present invention, however, can analyze the client-to-proxy data 210 or the system-to-proxy data 111 and use the results of such analysis to perform specific actions. Such actions include, but are not limited to, modification of the proxy-to-system data 111 from the original client-to-proxy data 210, modification of the proxy-to-client data 210 from the original system-to-proxy data 111, or interaction with a Device 101.

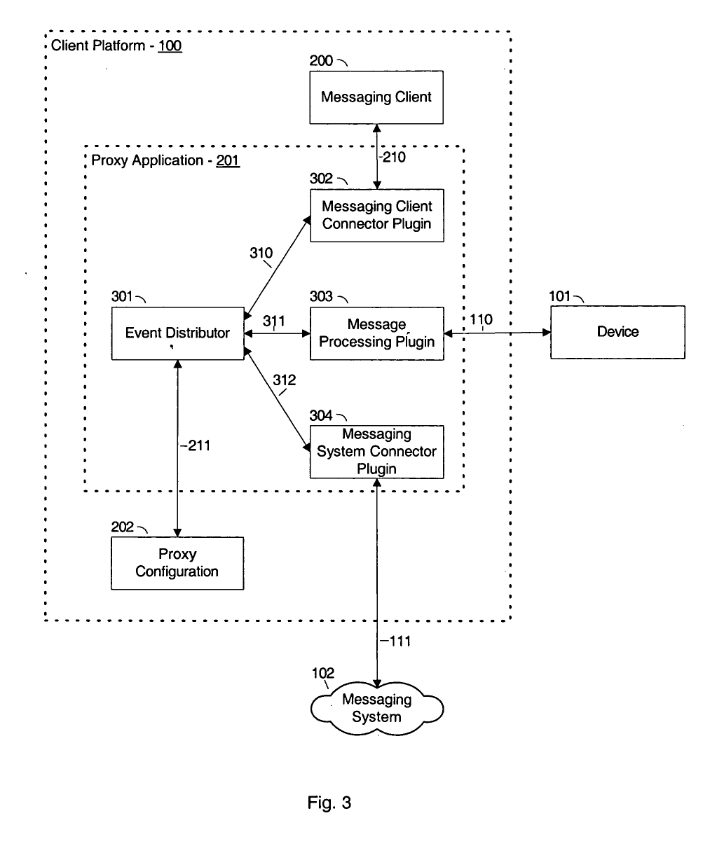

As depicted in FIG. 3, in the preferred embodiment, the Proxy Application 201 is designed as a generic event distribution system in which plugin components are responsible for all event production and processing. The plugin components can be developed separately from the core Proxy Application code yet dynamically linked into the Proxy Application 201 at runtime. Mechanisms used to support this dynamic runtime linking include Java Classes, Windows Dynamic Link Libraries, and Unix Shared Libraries. The core of the Proxy Application 201 is the Event Distributor 301, which periodically reads the Proxy Configuration 202 in order to determine which plugin components should be loaded, and then updates the set of currently loaded plugin components as required. At load time, plugin components can register with the Event Distributor 301 an interest in certain types of events. An event is a buffer of data that is tagged with a type identifier indicating correct interpretation of the data. If a plugin registers interest in an event type, it also registers a priority, which is used by the Event Distributor 301 to prioritize distribution of events when they are received. After being loaded into the Proxy Application 201, plugin components can create events and request that the Event Distributor 301 process those events. Upon receipt of an event, the Event Distributor 301 determines the list of plugins that have registered interest in the event's type and then distributes the event to the first registered plugin based on the priorities established when the plugins were registered. When the first plugin completes its processing of the event, the plugin returns the event to the Event Distributor 301 for further processing. If there are additional plugins with lower priority that have registered interest in the event, the Event Distributor 301 distributes the event to the plugin with the next highest priority. This process continues in priority order until all of the plugins with registered interest in the event have had an opportunity to process the event. Note also that plugins can modify the content of an event, and when there are multiple plugins processing the same event, each plugin receives the event as modified by the prior plugin.

FIG. 3 depicts an example in which three plugin components are loaded into the Proxy Application 201: the Messaging Client Connector Plugin 302, the Message Processing Plugin 303, and the Messaging System Connector Plugin 304. The purpose of the Messaging Client Connector Plugin 302 is to transmit data to and from the Messaging Client 200. The purpose of the Messaging System Connector Plugin 304 is to transmit data to and from the Messaging System 102. The purpose of the Message Processing Plugin 303 is to process messages received from the Messaging Client 200 or from the Messaging System 102. In this example configuration, there are two main types of events: system-to-client message events and the client-to-system message events. (The Device 101 can also generate events.) The Message Processing Plugin 303 and Messaging Client Connector Plugin 302 register interest in the system-to-client message event type with priorities 1 and 2 respectively. The Message Processing Plugin 303 and Messaging System Connector Plugin 304 register interest in the client-to-system message event type with priorities 1 and 2 respectively. After loading and registration, the Messaging Client Connector Plugin 302 configures the platform so that the Plugin 302 functions as a messaging proxy for the Messaging Client 200 and awaits messages. Upon receiving a message, the Messaging Client Connector Plugin 302 creates a corresponding client-to-system message event with the contents of the received message. The Messaging Client Connector Plugin 302 sends the event to the Event Distributor 301 for processing. The Event Distributor 301 determines that the Message Processing Plugin 303 and the Messaging System Connector Plugin 304 have registered interest in the new event's type, in that priority order. The Event Distributor 301 sends the event to the Message Processing Plugin 303, which processes the event as appropriate: for example, by sending a command to Device 101 based on the emoticon content of the event's message. After the Message Processing Plugin 303 has processed the event, the Event Distributor 301 sends the event to the Messaging System Connector Plugin 304, which has registered the next highest priority interest in the event's type. The Messaging System Connector Plugin 304 extracts the message content from the event and forwards the message to the Messaging System 102. Messages sent from the Messaging System 102 to the Messaging Client 200 are processed in the reverse order: the Messaging System Connector Plugin 304 receives a message from the Messaging System 102, creates a corresponding system-to-client message event, and requests that the Event Distributor 301 processes the event. The Event Distributor 301 sends the event to the Message Processing Plugin 303, which processes the event as appropriate. Then, the Event Distributor 301 sends the event to the Messaging Client Connector Plugin 302, which extracts the message content from the event and forwards the message to the Messaging Client 200.

As noted, FIG. 3 depicts a very simple set of Proxy Application 201 plugin components and event processing. Multiple instances of Messaging Client Connector Plugins 302 and Messaging System Connector Plugins 304 can be loaded in order to support multiple messaging protocols or multiple local messaging users. Multiple Message Processing Plugins 303 can be configured to process events. Events may be more complex than simple client-to-system or system-to-client messages. Other events include, but are not limited to, other notification information common to Instant Messaging systems, such as presence notifications (idle, busy, online, offline, etc), activity notifications (typing, buzz, etc), administrative notifications (buddy list updates, etc), and session management notifications (request to chat, request for video conference, etc). Some of these notifications are sent bi-directionally, both from Messaging System 102 to Messaging Client 200 and from Messaging Client 200 to Messaging System 102. The plugins can utilize not only the content of a message or notification event, but also metadata, such as the source or destination messaging user identity. For example, a plugin can be configured to control a Device 101 based on receipt of emoticon message content only from certain users.

Plugins can interact with non-messaging information systems either to create new events or to affect processing of existing events. Example non-messaging information includes, but is not limited to: current time, type/number/configuration of attached peripheral device(s), email and calendar data (examples of Other Internal Information 203 in FIG. 1); real world meteorological data, real world stock market fluctuations, and real world street traffic information (examples of Other External Information 103 in FIG. 1). In FIG. 1, general non-messaging information input is represented by link 212 from Other Internal Information 203 and link 112 from Other External Information 103, while link 110 represents the special case of input data from a Device 101. Plugins can also interact directly with API's or configuration variables provided by Messaging Clients 200 or Messaging Systems 102, or access any data or system resource that is explicitly exposed, such as Windows events.

Plugins can maintain state between received events. For example, a plugin could be configured to trigger Device 101 actions only after a specific number of messages have been received with specific message content and within a specific period of time.

In addition, plugins can modify the data content of an event, which can affect the processing of other plugins that have registered interest in the same event type but at a lower priority. As an example, a plugin could register interest in all client-to-system message events and modify all received events by encrypting the message content. A corresponding plugin could register interest in system-to-client message events and perform the corresponding message decryption. A plugin can also request that the Event Distributor 301 cease further distribution of an event after the current plugin has completed.

While the above sections describe the more complex capabilities of plugins, the Proxy Application 201 can be configured more simply to pass messages between Messaging Client 200 and Messaging System 102 without modification. In FIG. 3, if the Proxy Application 201 is configured not to load the Message Processing Plugin 303, then the Proxy Application 201 transmits messages between Messaging Client 200 and Messaging System 102 as if the Proxy Application 201 were not present.

While the event processing and plugin design allow for complex processing and manipulation of messages and usage of other information sources, the present invention focuses on the ability of plugins to interact with Devices 101. A Device 101 can connect to the client platform via any standard or proprietary interface, including, but not limited to, serial (RS-232), parallel (Centronics), USB, Bluetooth, and 802.11 WiFi. A Device 101 can provide both input and output sensory capabilities. Output mechanisms may include, but are not limited to, LEDs, LCD displays, audio speakers, actuators, and motors. Input mechanisms include, but are not limited to, buttons, audio/video input, and various sensors such as tilt, light, and motion.

For example, a simple Device 101 connected to the Proxy Application 201 could take the form of a children's doll. Output capabilities of the doll could include an audio speaker and actuators to manipulate the doll's facial expression and appendages. Input capabilities of the doll could include tilt and light sensors. In an Instant Messaging (IM) environment, example interactions between the Proxy Application 201 plugins, the Messaging Client 200, the Messaging System 102, and the doll (Device 101) could include: notification of IM buddy online/offline status causes doll to wave hand and output a greeting/farewell audio clip; happy/sad emoticons received in IM messages change doll's facial expression and output a corresponding audio clip, such as laugher or crying; tilting the doll horizontally or turning off ambient lights cause an offline IM status to be sent to the Messaging System on behalf of the local client; IM messages received when the local IM status is offline (due to tilt/light sensors) are responded to automatically with a “user is sleeping” message similar to email “out-of-office” auto-responses.

FIG. 2 illustrates configuration aspects of the invention. On the Client Platform 100, the Proxy Application 201 reads its plugin configuration information from the Proxy Configuration 202, which is configurable either internally (from the client platform itself) or remotely. The Proxy Configuration 202 can be stored using mechanisms such as, but not limited to, files, databases, and operating system specific configuration repositories such as the Windows Registry. The Proxy Configuration 202 includes the list of configured plugins as well as any configuration data specific to those plugins. Configuration data can include, but is not limited to, audio, video, and image files. Conceptually, the Proxy Configuration 202 is a set of configuration parameters with associated values. The parameter values can be numbers or text, or more complex values such as audio, video, or image files.

An Internal Configuration Means 204 can be a software application, a browser-based application, a text editor, or any other means by which a user can view the configuration parameters and view or modify the values associated with the configuration parameters.

A useful attribute for remote communication is the ability of local and remote users to share a common mental representation of what is being communicated. Because the configuration of the Proxy Application 201 affects the presentation of messages, it is desirable to allow remote users to view the local Proxy Configuration 202. The present invention accomplishes this by providing for External Configuration Means 104, which can simulate on a remote platform the presentation of any messages sent to the local Messaging Client 200. This allows both local and remote users to maintain a common perception of the communications.

External Configuration Means 104 include, but are not limited to, HTTP, file system sharing (such as via NFS), remote Windows Registry access, and direct access via custom protocols. Local Proxy Configuration 202 can be accessed directly by remote clients, or the access can be indirect through intermediate servers. One option for providing remote access to the local Proxy Configuration 202 is by HTTP put requests to a centralized configuration server, which stores the configuration in a database. The database can store configuration data for multiple clients. The configuration server provides access to remote Proxy Configurations 202 via HTTP get requests. The configuration server can secure the configuration data so that users are required to log in and are only allowed to view the configuration data as authorized. The configuration server can also allow authorized users to modify configuration data, so that remote users could control how their messages are presented to another messaging user.

In an alternative embodiment, rather than inserting a proxy between the messaging client and the messaging system, the proxy application can function solely by monitoring the messages that are transmitted to or from the messaging client, and sending messages to a device based on the messages.

We claim:

1. A transparent proxy application for a messaging system comprising
a) a client platform;
b) a messaging client;
c) said proxy application;
d) a proxy configuration;
e) a messaging system;
f) a device; and
g) a configuration means;
wherein
said messaging client, said proxy application, and said proxy configuration reside on
said client platform; and
wherein
said configuration means may reside either on said client platform or remotely; and
wherein
said proxy application can monitor or modify messages transmitted from said messaging client to said messaging system and can monitor or modify messages transmitted from said messaging system to said messaging client; and
wherein
said proxy application can send commands to said device; and
wherein
said proxy application can monitor said device and transmit messages to said messaging client or to said messaging system based on information received from said device; and
wherein
said proxy configuration comprises configuration parameters and associated values for each of said configuration parameters; and
wherein
said proxy application and said device determine the set of said configuration parameters; and
wherein
said configuration means can view or modify the value associated with any of said configuration parameters; and
wherein
said proxy application functions without modification to said messaging client and without modification to said messaging system.

2. The invention of claim 1 additionally comprising
h) a second messaging client; and
i) a second messaging system;
wherein
said proxy application can monitor or modify messages from said second messaging client to said second messaging system and said proxy application can monitor or modify messages from said second messaging system to said second messaging client; and
wherein
said proxy application functions without modification to said second messaging client and without modification to said second messaging system.

3. The invention of claim 1 additionally comprising
h) a plurality of messaging clients; and
i) a plurality of messaging systems;
wherein
said proxy application can monitor or modify messages from any of said plurality of messaging clients to any of said plurality of said messaging systems and said proxy application can monitor or modify messages from any of said plurality of messaging systems to any of said plurality of said messaging clients; and
wherein
said proxy application functions without modification to any of said plurality of messaging clients and without modification to any of said plurality of messaging systems.

4. The invention of claim 1 additionally comprising a second device
wherein
said proxy application can send commands to said second device; and
wherein
said proxy application can monitor said second device and transmit messages to said messaging client or to said messaging system based on information received from said device.

5. The invention of claim 2 additionally comprising a second device
wherein
said proxy application can send commands to said second device; and
wherein
said proxy application can monitor said second device and transmit messages to said messaging client, to said second messaging client, to said messaging system, or to said second messaging system based on information received from said device.

6. The invention of claim 3 additionally comprising a second device
wherein
said proxy application can send commands to said second device; and
wherein
said proxy application can monitor said second device and transmit messages to said messaging client, to any of said plurality of messaging clients, to said messaging system, or to any of said plurality of messaging systems based on information received from said device.

7. The invention of claim 1 additionally comprising a plurality of devices
wherein
said proxy application can send commands to any of said plurality of devices; and
wherein
said proxy application can monitor any of said plurality of devices and transmit messages to said messaging client or to said messaging system based on information received from any of said plurality of devices.

8. The invention of claim 2 additionally comprising a plurality of devices
wherein
said proxy application can send commands to any of said plurality of devices; and
wherein
said proxy application can monitor any of said plurality of devices and transmit messages to said messaging client, to said second messaging client, to said messaging system, or to said second messaging system based on information received from any of said plurality of devices.

9. The invention of claim 3 additionally comprising a plurality of devices
wherein
said proxy application can send commands to any of said plurality of devices; and
wherein
said proxy application can monitor any of said plurality of devices and transmit messages to said messaging client, to any of said plurality of messaging clients, to said messaging system, or to any of said plurality of messaging systems based on information received from any of said plurality of devices.

10. A transparent proxy application for a messaging system comprising
a) a client platform;
b) a messaging client;
c) said proxy application;
d) a messaging system; and
e) a device;
wherein
said messaging client, and said proxy application reside on said client platform; and
wherein
said proxy application can monitor messages transmitted from said messaging client to said messaging system and can monitor messages transmitted from said messaging system to said messaging client; and
wherein
said proxy application can send commands to said device; and
wherein
said proxy application functions without code modification to said messaging client and without modification to said messaging system.

11. A method of controlling a device, comprising:
monitoring messages to or from a messaging client; and
sending commands to said device based on the content of said messages
wherein no code changes to the messaging client are required.
